(19) United States
(12) Patent Application Publication
(10) Pub. No.: US 2017/0347621 A1
(43) Pub. Date: Dec. 7, 2017

(54) HORSE MATTRESSES AND RELATED METHODS OF USE

(71) Applicant: Lucy Vawn Jeddry, Beaumont (CA)

(72) Inventor: Lucy Vawn Jeddry, Beaumont (CA)

(21) Appl. No.: 15/175,729

(22) Filed: Jun. 7, 2016

(51) Int. Cl. A01K 1/015

(52) U.S. Cl. CPC A01K 1/0157; A01K 1/0155

(57) ABSTRACT

A horse mattress has a hollow body formed by a top bedding layer and a ground contacting base layer connected together to define an internal chamber, the top bedding layer being water resistant and sized to accommodate a horse; loose fill material within the internal chamber; a fill opening defined by the hollow body for adding and removing loose fill material to and from the internal chamber; and a reversible closure part for opening and closing the fill opening. A method includes supplying loose fill material into an internal chamber of a hollow body through a fill opening defined by the hollow body, the hollow body being water resistant; reversibly closing the fill opening; and placing the hollow body on a ground surface in a horse stall to provide a bed for a horse.

### TECHNICAL FIELD

This document relates to horse bedding.

### BACKGROUND

Bedding options for a horse stall includes loose material, such as hay or wood shavings, and permanent matting spanning the lateral dimensions of the horse stall. Loose material provides sufficient cushion and comfort to the horse, and is mucked out at regular intervals to remove soiled material and avoid pest infestation. Permanent matting provides a cushioned, water proof surface.

### SUMMARY

Portable, washable, low-maintenance, cushioned mattresses for horses are disclosed in one case.

A horse mattress comprising: a hollow body formed by a top bedding layer and a ground contacting base layer connected together to define an internal chamber, the top bedding layer being water resistant and sized to accommodate a horse; loose fill material within the internal chamber; a fill opening defined by the hollow body for adding and removing loose fill material to and from the internal chamber; and a reversible closure part for opening and closing the fill opening.

A method is disclosed comprising: supplying loose fill material into an internal chamber of a hollow body through a fill opening defined by the hollow body, the hollow body being water resistant; reversibly closing the fill opening; and placing the hollow body on a ground surface in a horse stall to provide a bed for a horse.

A horse mattress is disclosed that is made of one or more water resistant panels, each filled with loose wood shavings. A horse mattress or bed may be made of one or more water resistant panels, each filled with hay. Two or more adjacent panels may be connected together by straps to make a larger mattress. A removable cover may overlie one or more panels.

A horse mattress is disclosed that has panels, each panel having vertical side walls, with adjacent panels being joined by tensioning devices, with the vertical side walls including flat fasteners, thus allowing the vertical side walls of abutting panels to be pulled together to join panels while permitting the vertical side walls to secure a cover when the vertical side walls are on the outside of the mats.

In various embodiments, there may be included any one or more of the following features: The loose fill material comprises hay. The loose fill material comprises one or more of wood shavings, wood chips, and shredded newspaper. The hollow body forms a flexible structure adapted to one or more of fold and roll up into a compact stowed position when the fill material is emptied from the internal chamber. The internal chamber comprises plural internal chambers separated by a divider wall, with each of the plural internal chambers containing loose fill material. The fill opening extends across the plural internal chambers. The top bedding layer forms a continuous horizontal upper surface that overlies adjacent of the plural internal chambers and crosses the divider wall in a direction transverse the divider wall. The hollow body comprises plural sidewalls separating the top bedding surface and the ground contacting base layer, with the fill opening extending longitudinally along one or more of the plural sidewalls. The reversible closure part comprises one or more of a zipper, a flap, and a lace closure. The top bedding layer displays a beige or brown color. A shakeout strap connected to an external part of the hollow body. The shakeout strap comprises a pair of shakeout straps located at respective corners of the hollow body. The shakeout strap comprises an eyelet defining an opening smaller than a horse's hoof. The hollow body comprises ballistic nylon. The top bedding layer defines a length of at least six feet, and a width of at least six feet. A horse mattress is deployed in a horse stall located in a barn, a trailer, or a shelter. Loose fill material rests on top of the top bedding layer. Reversibly opening the fill opening; replacing the loose fill material in the interior chamber with more loose fill material; and reversibly closing the fill opening. Hanging the hollow body on a wall; cleaning the hollow body with water; and returning the hollow body back to the ground surface in the horse stall. Emptying the loose fill material from the internal chamber; and folding, rolling up, or folding and rolling up the hollow body into a stowed position.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a perspective view of a horse mattress in use by a horse and positioned within a horse stall.

FIG. 1A is a section view of taken along the section lines 1A-1A, in FIG. 1.

FIG. 2 is a perspective view of the horse mattress depicted in FIG. 1 with a divider wall shown in dashed lines, and incorporating a zipper closure mechanism.

FIG. 2A is a side elevation view of a part of a horse mattress that incorporates a lace closure mechanism.

FIG. 3A is a side elevation view of the horse mattress depicted in FIG. 1 shown in a folded stowed position.

FIG. 3B is a side elevation view of the horse mattress depicted in FIG. 1 shown in a rolled stowed position.

FIG. 4 is a side elevation view of a further embodiment of a horse mattress formed by plural panels secured together via a fastening device.

FIG. 5 is a top plan view of a horse mattress formed by plural panels and shown with detachable covers fastened over the top surface of the mattress.

### DETAILED DESCRIPTION

Immaterial modifications may be made to the embodiments described here without departing from what is covered by the claims.

A horse stall is a temporary or permanent enclosure to house a horse for a period of time. A horse stall may have a roof, side walls and a gate for the horse to enter and exit. A stall may include bedding for the horse to lie down in and sleep upon. Such bedding may be made from hay or wood shavings that are changed or mucked regularly to maintain sanitary conditions for the horse. Loose bedding requires a suitable disposal area to dispose of the soiled bedding to avoid attracting unwanted insects or other pests into the horse stall or barn. Supplying, maintaining, replacing, and removing loose material can be a labor intensive task for a horse owner.

In some cases permanent matting may be used in addition to or instead of loose bedding material. Such matting is made from soft foam mats that are lined on the stall floor surface to provide heat insulation and comfort for the horse. Such matting may temporarily alleviate some of the labor of dealing with loose bedding but is expensive and complex to install, and still requires that the stall be mucked regularly to clean soiled areas of the matting. Eventually, even permanent matting must be changed out.

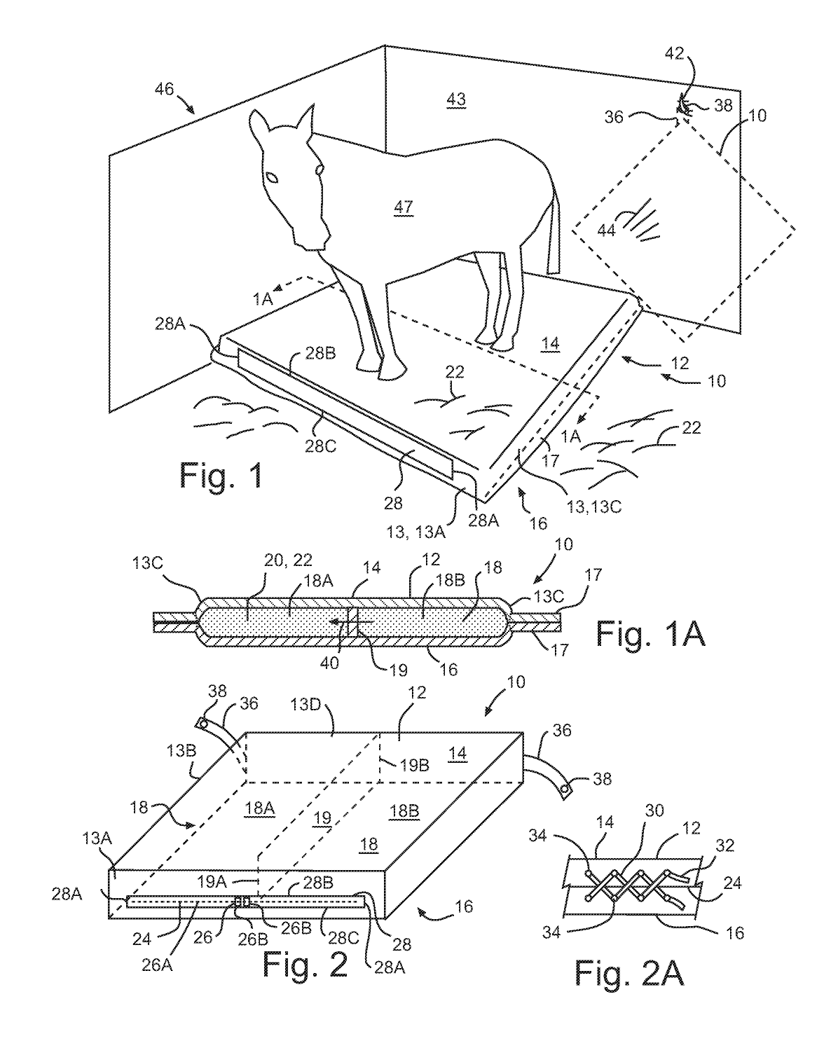

Referring to FIG. 1, a horse mattress 10 is illustrated having a hollow body 12 formed by a top bedding layer 14 and a ground contacting base layer 16. The top bedding layer 14 may be water resistant, for example water proof. Layer 14 may be UV resistant. Base layer 16 and other parts of hollow body 12 may be water resistant or water proof. Horse mattress 10 may be deployed in a horse stall 46, such as is located in a barn, a trailer, or a shelter. Horse mattress 10 may also be deployed in a turnout area, paddock or pasture. Hollow body 12 may be formed by a suitable method such as by sewing the top layer 14 and bottom layer 16 together, for example to adopt the shape of a relatively flat bag or envelope. For example, as shown in FIG. 1A, the perimeter edges of the top bedding layer 14 and base layer 16 converge and are connected together along cooperating flanges 17 to give hollow body 12 a bag or envelope shape.

Referring to FIG. 1A, the top bedding layer 14 and the ground contacting base layer 16 may be connected together to define an internal chamber 18. Referring to FIG. 2, hollow body 12 may comprise plural sidewalls 13 as part of layers 14 and/or 16 or as separate parts connected to layers 14 and 16. Sidewalls 13 may include a suitable number and shape of walls such as a front wall 13A, left wall 13B, right wall 13C and rear wall 13D. Sidewalls 13 may separate the top bedding surface or layer 14 and the ground contacting base layer 16 to define the chamber 18. Referring to FIG. 1A, the internal chamber 18 may be filled partially or fully with a loose fill material 20, for example filled to a sufficient extent to form a supportive and cushioned core for a horse to sit or lie upon. Loose fill material 20 may comprise suitable material such as hay 22, wood shavings, wood chips, shredded newspaper, recycled material, or a combination of plural material types.

Referring to FIG. 2, hollow body 12 may define a fill opening 24 for adding and removing loose fill material 20 to and from the internal chamber 18. Fill opening 24 may be located at a suitable location onto the body 12, for example along the front wall 13A. Fill opening 24 may comprise a reversible closure part 26 for opening and closing the fill opening 24. A reversible closure part 26 may be designed to permit a user, such a farm hand, to manually open and close the fill opening 24 in a convenient, repeatable manner, without damaging the mattress. Various degrees of reversibility may be achieved by part 26, such as from a) a degree where the part 26 may be operated by hands only without tools and in some cases without complex movements, with an example of type a) being the case of a zipper or hook and loop fastener, to b) a degree where it is inconvenient to manually operate the part 26, for example in the case of a lace closure, or a wingnut and bolt combination, or where simple tools are required such as a key to unlock a padlock. Parts 26 may exclude closure mechanisms the opening of which would damage the mattress, for example welds, bonds, stitches, staples, nails, and adhesives.

A suitable reversible lock or closure part 26 may comprise one or more of a zipper (FIG. 2), a flap 28 (FIGS. 1 and 2), or lace closure 30 (FIG. 2A). Other suitable closure parts may be used such as hook and loop fasteners (not shown). Fill opening 24 may extend longitudinally along a part or the entirety of one or more of the plural sidewalls 13, for example along a substantial part of the length of side wall 13A as shown. In another case the fill opening 24 may be located on one of the layers 14 and 16. Plural openings 24 may be used, such as on respective side walls 13 of the hollow body 12, or for accessing respective internal chambers 18 of the body 12.

Referring to FIG. 2, the zipper may comprise a coil zipper made of spiral elements such as nylon elements. A zipper, also known as a zip, fly or zip fastener, or clasp locker, may comprise parallel rows of zipper teeth 26A with one or more zipper sliders 26B mounted to interlock and spread the zipper teeth 26A in use. Zipper sliders 26B may be slid together to a position near the center of the row of zipper teeth 26A when the teeth are in the closed position. However, in the example shown the sliders 26B are free to meet at any point along the longitudinal length of the rows of teeth 26A. The sliders 26B may be slid to respective positions near the opposed edges of the fill opening 24 when the teeth are in the open position. A pair of sliders 26B on the same tracks of teeth 26A may be advantageous for selectively accessing a single compartment or chamber 18A or 18B of the internal chamber 18 as discussed in further detail below. Other suitable types of zippers may be used, such as invisible zippers, reverse coil zippers, metal zippers, plastic-molded zippers, open-ended zippers, and two way open-ended zippers. In one mattress 10 tested, a #10 Coil YKK™ zipper was used—the largest standard size made by YKK, with a zipper pull # PU-C10 or PUC10.

Referring to FIGS. 1 and 2, flap 28 may be provided as an independent reversible closure part 26, or may cooperate with another reversible closure part such as a zipper to limit exposure of the fill opening when closed. The flap 28 may connect to the hollow body 12 in a suitable fashion. In one case, a top edge 28B of the flap 28 may be connected to the mattress, for example sewn longitudinally along the side wall 13A of the mattress adjacent the top layer 14. Side edges 28A of the flap 28 may be connected to the side wall 13A of the mattress adjacent the side walls 13A and 13C. A base edge 28C of the flap 28 may loosely rest upon and otherwise be left not connected to the side wall 13A to allow access to the fill opening 24 by lifting or pulling the flap away from the side wall 13A. In some cases the side edges 28A and/or top edge 28B may not be connected to the hollow body 12. In some cases flap 28 seals the fill material in the internal chamber 18 without the use of a zipper or other closure part 26. In some cases the flap 28 is installed on an internal surface of the hollow body 12, such as in internal chamber 18, and in some cases there are respective flaps on the external and internal surfaces of the hollow body.

Referring to FIG. 2A, lace closure 30 may comprise one or more ties or laces 32 with a corresponding part to secure the laces, for example a series of aligned eyelets, such as defined by grommets 34 along the longitudinal length of the fill opening 24. Laces 32 may weave through grommets 34 to provide a mesh that, upon tightening, seals fill opening 24. Laces 32 may also be used in a non-mesh arrangement, such as a drawstring mounted in a corresponding channel encircling the fill opening 24 for constricting and expanding the opening 24 by tightening and loosening, respectively the laces 32. Lace closure 30 may also be used in combination with flap 28 as described above or with other reversible closure parts 26. Laces 32 may comprise of a material with high tensile strength, such as synthetic nylon.

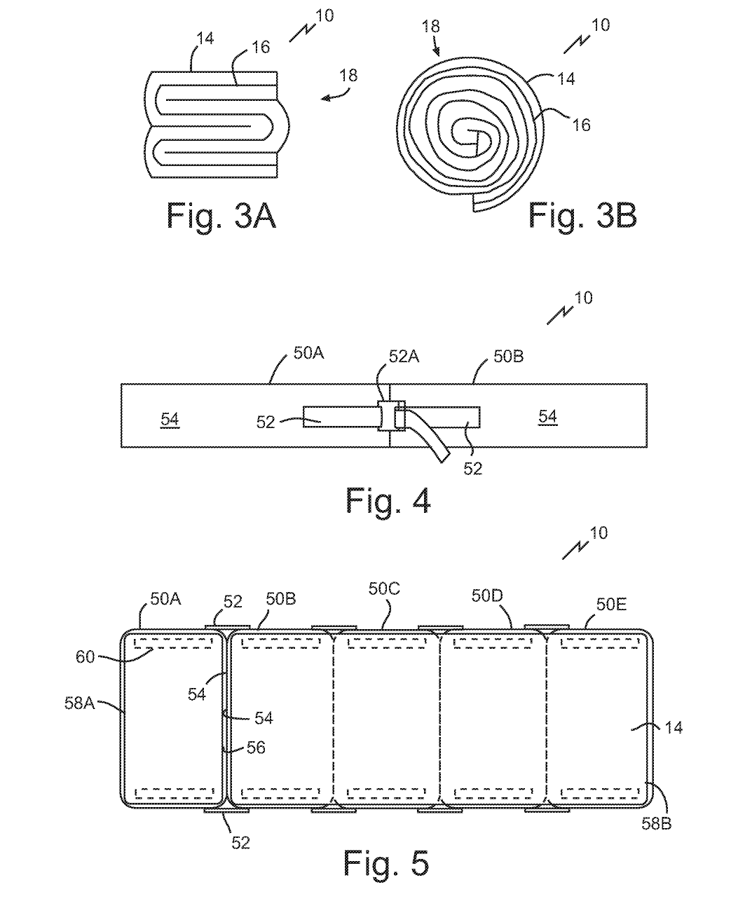

Referring to FIGS. 2, 3A and 3B, horse mattress 10 may be structured to adopt a deployed position when the internal chamber 18 is filled with fill material 20 and a compact stowed position when the chamber 18 is emptied, either wholly or partially. For example, hollow body 12 forms a flexible structure adapted to fold (FIG. 3A), roll up (FIG. 3B), or both, into the stowed position when the fill material 20 is emptied from the internal chamber 18. The stowed position may facilitate the movement, transport, and storage of the horse mattress 10. The interconversion between a deployed and stowed position may be advantageous for traveling to a remote site, such as a competition or show. For example, horse mattress 10 may be initially filled and placed in a deployed position within a stall occupied by the horse. When a user desires to transport the horse to the remote location, the mattress 10 may be emptied and rolled into a stowed position and transported to the remote location, for example to a stall at or near a competition site. Once at the remote stall the mattress 10 may be filled and deployed. In another case mattress 10 may remain filled and be deployed in a trailer for use by the horse during transit within the trailer or another suitable transport vehicle. Once the horse and bedding arrive at the remote site, the bedding may be stowed or deployed for use by the horse in a stall. The mattress 10 may be stowed or deployed during transport back to the initial stall, and upon return may be once again deployed in the initial stall.

Referring to FIG. 2, internal chamber 18 may comprise plural internal chambers 18A, 18B that may be separated by a divider wall 19, such as a central baffle. Divider wall 19 may extend from the rear wall 13D to at or near the fill opening 24 (near placement being shown in FIG. 2). The rear end 19B of the wall 19 may be connected to the rear wall 13D of the body 12. The front edge or end 19A of the wall 19 may form a free end or may be connected to another of walls 13, such as front wall 13A. Each of the plural internal chambers 18A, 18B may contain loose fill material. Divider wall 19 may provide a separation in internal chamber 18 to help prevent fill material 20 from aggregating on one part or side of mattress 10. The fill opening 24 may extend across the plural internal chambers 18A, 18B, permitting simultaneous access to both chambers via the fill opening 24. Referring to FIG. 1A, top bedding layer 14 may form a continuous surface, such as a continuous horizontal upper surface, overlying adjacent of the plural internal chambers 18A, 18B. Thus, as shown the continuous horizontal topography proceeds from one part of layer 14 above chamber 18B across the wall 19 in a direction 40 transverse the divider wall 19, and over top of chamber 18A, to avoid dips or crevasses that may trip up the horse. In one mattress 10 that was tested, the wall 19 had a 2 mm foam sandwich mesh polyester/nylon tricot cover on one side, a heavy nylon mesh on the other side, with a filament mesh in between.

Referring to FIG. 2, horse mattress 10 may comprise a shakeout strap or straps 36 connected to an external part, such as sidewalls 13, of the hollow body 12. Shakeout strap 36 may provide a handle for the user to lift the body 12 to shake the body 12 to uniformly distribute any fill material that has aggregated unevenly within the chamber 18. Strap 36 may also permit the body 12 to be lifted off of the ground to empty the fill contents of the inner chamber 18 through the fill opening 24. Shakeout strap 36 may comprise a strip of material with a free end, such as a belt, tongue, or ribbon to prevent the horse from getting caught on mattress 10 by stepping into a strap with a loop or ring. Shakeout strap 36 may comprise a plurality of shakeout straps, for example located at respective adjacent or opposed corners of the hollow body for easier handling.

Shakeout strap 36 may facilitate the cleaning or emptying of the mattress 10. For example, strap 36 may comprise a hanging mechanism such as an eyelet, for example defined by a grommet 38, that may be used to hang horse mattress 10 off the ground. For example, the grommet 38 is hung on a hook 42 on the wall 43 of the stall 46 in one case. Water, such as a spray of water 44 from a hose (not shown) may be used to clean the mattress 10, with or without the aid of cleaning agent such as soap. Grommet 38 may define an opening smaller than, for example less than ⅓ the base area of, a horse's hoof to prevent the horse from getting caught or tripping on the eyelet. An eyelet or hanging mechanism may be provided elsewhere on the mattress 10 for hanging the mattress 10, for example a hook, loop, or eyelet on the base layer 16 (not shown) away from access by the horse.

Referring to FIG. 1, hollow body 12 or part of it may be one or more of scratch, puncture, and tear resistant, in some cases tough enough to be walked on by a horse with horse shoes. Layer 14 may comprise a suitable ballistic nylon, such as a fabric made with a ballistic weave. For example, a 1680 denier coated ballistic nylon fabric was used in a horse mattress 10 that was tested. Ballistic nylon is a thick, tough, synthetic nylon fabric. Ballistic nylon may be woven from nylon yarns of various denier such as 840 denier and 1680 denier. Denier refers to the weight, not the strength, of the fabric. A double weave 1050 denier fabric may be the strongest and most durable of such fabrics for its denier weight level. However, the 1680 denier has a strength to the 1050 but lighter weight and resists abrasion and tearing. Some varieties of ballistic nylon have a 2×2, 2×3, or other basket weave and provide a rough fabric surface for the horse to step on without risking damage to mattress 10. In one mattress 10 that was tested, layer 14 had a nominal fabric thickness of 0.020 inches (0.5 mm) and a nominal fabric weight of 10.7 oz. per sq. yard.

Layer 14 may comprise a biopolymer, such as OSMO™ Elite waterproof biopolymer or a comparable biopolymer light weight fabric. Bedding layer 14 may comprise a polyurethane inner surface and a water repellent or water proof outer surface or finish. A polymer finish, such as a hydrophobic polymer finish, may provide horse mattress 10 with stain repellency and ease of cleaning. Denier ratings of 800-2000 may be used, as well as other ranges of density. Referring to FIG. 1, base layer 16 may comprise a heavy duty material such as 500 denier CORDURA™ nylon fabric, which may provide a natural spun-like appearance, with resistance to fading, abrasion, rot and mildew. Base layer 16 may comprise a biopolymer, such as DUPONT™ SORONA™ biopolymer, or hypalon. In one mattress that was tested, layer 16 had approximately 0.75-1.0 oz/sq. yd. clear urethane coating, with a nominal fabric weight of 8 oz. per sq. yard, and a nominal fabric width of 59-60 inches (150-152 cm).

Individual parts of hollow body 12 or hollow body 12 as a whole may comprise a suitable coating or composition that provides a water resistant/proof characteristic, for example rubber, polyvinyl chloride (PVC), polyurethane, and silicone elastomers. Stitching of hollow body may be applied such as to be visible only from the interior, for example by sewing the layers 14 and 16 together and then turning the structure inside out to provide hollow body 12, to reduce horse access to stitching, and to reduce exposure to liquids. Stitching may comprise heavy duty thread and may be reinforced by BEMIS™ seam tape. In one mattress 10 that was tested, thread comprised 10 oz. CONES™ STRONGBOND™ 40 bonded nylon thread, with a needle of jeans 100/18.

The layer 14 may be sized to accommodate a horse 47. For example, the layer 14 may be sized to accommodate the length of the horse when resting or lying on the layer 14. Top bedding layer may define a length of at least six feet, and a width of at least six feet. An example sizing chart is shown in Table 1 below. In some cases when full the mattress 10 may define a depth or height of 6 inches. Other sizes and dimensions may be suitable to accommodate a horse, such as larger or smaller sizes. Mattress 10 may provide a single, continuous unit without modules or plural, discreet panels. Such a mattress 10 may provide a continuous horizontal surface without bumps, divots, crevasses, or seams, to minimize the risk of tripping or disturbing the gait of the horse. In other cases a plurality of mattresses 10 may be used to expand the bedding area for larger horses.

TABLE 1
Example sizing chart

| | Mattress Dimension | Approx. Horse | |
|---|---|---|---|
| Size | (length × height × depth) | Height | |
| Extra Small | 6′ × 2′ × 8″ | 6-10 | HH |
| Small | 6′ × 4′ × 8″ | 11-14 | HH |
| Medium | 6′ × 6′ × 8″ | 15-16 | HH |
| Large | 6′ × 8′ × 8″ | 16-17.5 | HH |
| Extra Large | 6′ × 10′ × 8″ | 18 | HH Plus |

Referring to FIG. 1, horse mattress 10 may be configured to facilitate introduction to the horse 47. For example, loose fill material 20 may be at least initially placed on top of the top bedding layer 14 to camouflage the mattress 10. Top bedding layer 14 may display a beige or brown color, simulating an outdoor or stall environment that the horse is accustomed to.

Referring to FIGS. 1 and 2 the use of the mattress 10 may reduce, relative to conventional stall bedding, one or more of the demands of maintenance, material, capital cost, disposal and expense of providing a safe, comfortable, and sanitary living environment for a horse. Loose fill material contained within the mattress 10 may be protected from contamination by horse excrement, urine, external elements, and pests, thus prolonging the use of the loose fill material as a supportive core, and reducing the need and expense to replace the loose fill material. Further synergy may be achieved when the horse mattress 10 is stuffed with the same loose fill material already in use as stall bedding, such as hay or wood shavings, as the mattress 10 prolongs the life and reduces maintenance of such bedding. The exterior of the mattress 10 may be cleaned when necessary. A further discovery that was made is that the horse will typically avoid soiling (defecating or urinating) on the mattress 10, thus reducing the demands of cleaning the mattress 10 from what was initially expected. Instead, the horse will typically choose to defecate or urinate in the other parts of the stall not covered by the mattress 10, reducing the total area that must be regularly cleaned in the stall. The loose fill material in the mattress may be periodically replaced as needed, for example to provide a fresh core of fill and to avoid a buildup of mold or deterioration of the loose fill material in the mattress 10 over time. The mattresses 10 disclosed here may reduce the demand for stall bedding by up to 75%, thus paying for itself within a short period of time such as a year or two. The mattress 10 may also relieve joint pain through cushioning.

Referring to FIG. 4 an embodiment of horse mattress 10 is depicted being formed by plural panels 50A and 50B (hollow bodies). Plural panels may collectively extend the size of mattress 10 to accommodate horses of varying sizes. Plural panels may be constructed of strong durable water resistant or water proof material. Plural panels 50A and 50B may be secured to one another via fastening devices 52, for example 1″ nylon straps 52, to make a larger bed. Fastening devices 52 may be secured on side walls, such as vertical side walls 54, or other suitable locations on each panel. Fastening device 52 may be fastened together via a coupling mechanism, such as a D-ring or quick release buckle 52A.

Referring to FIG. 5, a horse mattress 10 formed by a series of plural panels 50A-E is depicted. Plural panels 50A-E may be secured to one another via a suitable fastening device 52 such as is discussed above. Plural panels may comprise flat fasteners 56, such as cooperating hook and loop strips or touch fasteners, connected to vertical side walls 54. Flat fasteners 56 may allow the vertical side walls 54 of abutting panels to be pulled together to form a uniform, flush, and continuous horizontal bedding surface between adjacent panels 50. Horse mattress 10 may comprise a removable, in some cases water proof, cover 58A, 58B to limit exposure of the underlying mattress 10 to dirt, excrement and damage. Removable cover 58A overlies a single panel 50A in one case. In another case removable cover 58B overlies a plurality of panels such as panels 50B, 50C, 50D, 50E. The removable covers 58A or 58B may mount to the panels 50A-E via a suitable fastener such as a plurality of cooperating hook and loop fasteners 60, for example with one of the hook or loop part located on the upper bedding layer 14 of each panel, and the other part located on the removable cover 58A, 58B. Removable cover 58A, 58B may have suitable fasteners, such as hook and loop fasteners (not shown) that mate with fasteners 56 on vertical side walls 54 to secure the cover 58A, 58B when the vertical side walls 54 are on the outside of the mattress 10.

In some cases non-degradable or degradable loose fill material may be used. In some cases a solid core may be used, such as a polymeric or foam core. A mattress may have the shape of a relatively flat or thin pad, for example forming opposed top and base platforms separated by a relatively thin encircling or perimeter edge. Layers 14, 16, and sidewalls 13 may or may not be made of the same material. Layers 14 and 16 may be made of fabric sheets. Breathability of materials may be reduced, minimized, or altogether avoided to prevent or restrict premature fouling of the loose fill material, particularly if the fill material is bio-degradable. Loose fill material includes a body of material made up numerous small, loosely distributed, objects (such as hay), and includes particulates. Horse mattresses 10 disclosed herein may be used with other livestock such as donkeys, cattle, and llamas.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

The embodiments of the invention in which an exclusive property or privilege is claimed are defined as follows:

1. A horse mattress comprising:
a hollow body formed by a top bedding layer and a ground contacting base layer connected together to define an internal chamber, the top bedding layer being water resistant and sized to accommodate a horse;
loose fill material within the internal chamber;
a fill opening defined by the hollow body for adding and removing loose fill material to and from the internal chamber; and
a reversible closure part for opening and closing the fill opening.

2. The horse mattress of claim 1 in which the loose fill material comprises one or more of hay, wood shavings, wood chips, and shredded newspaper.

3. The horse mattress of claim 1 in which the hollow body forms a flexible structure adapted to one or more of fold and roll up into a compact stowed position when the fill material is emptied from the internal chamber.

4. The horse mattress of claim 1 in which the internal chamber comprises plural internal chambers separated by a divider wall, with each of the plural internal chambers containing loose fill material.

5. The horse mattress of claim 4 in which the fill opening extends across the plural internal chambers.

6. The horse mattress of claim 4 in which the top bedding layer forms a continuous horizontal upper surface that overlies adjacent of the plural internal chambers and crosses the divider wall in a direction transverse the divider wall.

7. The horse mattress of claim 1 in which the hollow body comprises plural sidewalls separating the top bedding layer and the ground contacting base layer, with the fill opening extending longitudinally along one or more of the plural sidewalls.

8. The horse mattress of claim 1 in which the reversible closure part comprises one or more of a zipper, a flap, and a lace closure.

9. The horse mattress of claim 1 in which the top bedding layer displays a beige or brown color.

10. The horse mattress of claim 1 further comprising a shakeout strap connected to an external part of the hollow body.

11. The horse mattress of claim 10 in which the shakeout strap comprises a pair of shakeout straps located at respective corners of the hollow body.

12. The horse mattress of claim 10 in which the shakeout strap comprises an eyelet defining an opening smaller than a horse's hoof.

13. The horse mattress of claim 1 in which the hollow body comprises ballistic nylon.

14. The horse mattress of claim 1 in which the top bedding layer defines a length of at least six feet, and a width of at least six feet.

15. An apparatus comprising the horse mattress of claim 1 deployed in a horse stall located in a barn, a trailer, or a shelter.

16. The apparatus of claim 15 further comprising loose fill material resting on top of the top bedding layer.

17. A method comprising:
supplying loose fill material into an internal chamber of a hollow body through a fill opening defined by the hollow body, the hollow body being water resistant;
reversibly closing the fill opening; and
placing the hollow body on a ground surface in a horse stall to provide a bed for a horse.

18. The method of claim 17 further comprising:
reversibly opening the fill opening;
replacing the loose fill material in the interior chamber with more loose fill material; and
reversibly closing the fill opening.

19. The method of claim 17 further comprising:
hanging the hollow body on a wall;
cleaning the hollow body with water; and
returning the hollow body back to the ground surface in the horse stall.

20. The method of claim 17 further comprising:
emptying the loose fill material from the internal chamber; and
folding, rolling up, or folding and rolling up the hollow body into a stowed position.
